(19) United States
(12) Patent Application Publication
(10) Pub. No.: US 2018/0161986 A1
(43) Pub. Date: Jun. 14, 2018

(54) SYSTEM AND METHOD FOR SEMANTIC SIMULTANEOUS LOCALIZATION AND MAPPING OF STATIC AND DYNAMIC OBJECTS

(71) Applicant: The Charles Stark Draper Laboratory, Inc., Cambridge, MA (US)

(72) Inventors: Vincent P. Kee, Cambridge, MA (US); Gian Luca Mariottini, Stoneham, MA (US)

(21) Appl. No.: 15/839,773

(22) Filed: Dec. 12, 2017

Related U.S. Application Data
(60) Provisional application No. 62/433,103, filed on Dec. 12, 2016.

(51) Int. Cl. B25J 9/16; G06T 7/73; G06T 17/05; G06K 9/00

(52) U.S. Cl. CPC B25J 9/1697; G06K 9/00671; G06T 17/05; G06T 7/75

(57) ABSTRACT

A system for Semantic Simultaneous Tracking, Object Registration, and 3D Mapping (STORM) can maintain a world map made of static and dynamic objects rather than 3D clouds of points, and can learn in real time semantic properties of objects, such as their mobility in a certain environment. This semantic information can be used by a robot to improve its navigation and localization capabilities by relying more on static objects than on movable objects for estimating location and orientation.

### FIELD OF THE INVENTION

This invention relates to camera-based vision systems, and more particularly to robotic vision systems used to identify and localize three-dimensional (3D) objects within a scene, build a map of the environment imaged by a sensor of a robot or other camera-guided device, and localize that sensor/device in the map.

### BACKGROUND OF THE INVENTION

For an autonomous mobile robot, building an accurate map of its surroundings and localizing itself in the map are critical capabilities for intelligent operation in an unknown environment using sensor data. Such sensor data can be generated from one or more types of sensors that sense (e.g.) visible and non-visible light, sound or other media reflected from the object in an active or passive mode. The sensor data received is thereby defined as point clouds, three-dimensional (3D) range images or any other form that characterizes objects in a 3D environment. This problem has been the focus of robotics research for the past few decades, as described in the Appendix hereinbelow at reference items [1], [2], [3], [4], the entire contents of which are referenced as useful background information. In the past ten (or more) years, practical SLAM (Simultaneous Localization and Mapping) techniques have been developed and successfully implemented on systems operating in the real world. One version/example of the SLAM approach is described in further detail by Appendix item [5], the entire contents of which are referenced as useful background information. A wide range of such approaches are disclosed and known to those of skill. However, the maps the algorithms construct are generally suited only for navigation as they are composed of low level geometric features such as points and lines without any associated higher level semantic meaning, as described by Appendix items [6], [7], [8], [9] the entire contents of which are referenced as useful background information.

Many object SLAM systems have been developed, utilizing different techniques for object tracking and SLAM. Galvez-Lopez et al., as described in Appendix item [11] incorporates bag of visual words object detection into monocular SLAM, thereby improving each system's performance. However, the map excludes the background, necessary for tasks such as navigation. Additionally, the object detection system suffers from the same inherent issues as bag-of-words-based models, ignoring spatial information between visual words (See Appendix item [12]). SLAM++ (see Appendix item [10]), an object oriented SLAM method, achieves significant map compression while generating dense surface reconstructions in real time. It identifies and tracks objects using geometric features and demonstrates robust mapping including relocalization and detection of when an object moves. However, rather than updating its map with moving objects, SLAM++ stops tracking these objects. Like the technique described in Appendix item [11], the generated map excludes the background. Sunderhauf et al. (Appendix item [11] integrates SLAM and deep learning for object detection and segmentation to create semantic, object-oriented maps without needing a prior database of object models. However, this approach does not leverage the semantic knowledge to improve localization and mapping. Choudhary et al. (Appendix item [14]) employs a deep learning approach for object detection. This approach uses a neural network to generate object bounding boxes (Appendix item [15]) to segment a point cloud for object pose estimation. Like the approach described in Appendix item [10], it achieves orders of magnitude map representation compression. The disclosure of Song et al. (Appendix item [16]), the entire contents of which is referenced as useful background information, integrates 3D reconstruction, localization, and crowd sourcing (similar to popular, internet-based systems, such as Google's ReCaptcha®) to substantially improve object recognition. Additionally, the disclosure of Choudhary et al. (Appendix item [17]) combines online object discovery and modeling with SLAM to improve loop closure detection. However, this technique cannot handle moving or repetitive objects. None of these approaches leverage prior semantic knowledge of objects mobility and identity to self-localize in an environment. SLAMMOT (See Appendix items [18], [19]) solves the SLAM and detection and tracking of moving objects (DATMO) problems by tracking moving and static objects with separate, extended Kalman filters. However, SLAMMOT creates sparse 2D maps that are insufficient for tasks using the map such as manipulation.

Most SLAM methods and approaches assume that the environment is static, or at least mostly static (See Appendix item [4]). SLAM algorithms designed for operating in dynamic environments use widely varying techniques to localize and maintain accurate maps. The disclosure of Wolf et al. (Appendix item [20]) uses occupancy grids to model static and dynamic parts of the environment. Dynamic Pose Graph SLAM (Appendix items [21], [22]) extends the pose graph SLAM model, as described in Appendix item [23], by representing low dynamic environments with separate static and dynamic components to construct 2D maps. DynamicFusion (see Appendix item [24]), a real time dense visual SLAM method, creates realistic surface reconstructions of dynamic scenes by transforming moving geometric models into fixed frames. The approach of Babu et al. (Appendix item [25]) tightly couples SLAM and manipulation for more robust motion planning and object manipulation in a static environment. Ma et al. (Appendix item [26]) discloses an integrated object manipulation into SLAM to discover unknown objects and generate higher quality object models. However, none of these techniques learn the mobility of objects. Most approaches incorporate knowledge from other systems, such as manipulation or planning architectures, to inform and improve localization and mapping.

Most existing SLAM solutions require a large memory in the associated image processor to maintain a detailed map of the environment as described in Appendix item [4], limiting scalability. In comparison, human navigation and interaction in an environment are not based on a fine 3D mapping of the environment, but rather a semantic recognition of salient objects and their positions and orientations, or poses. Semantic object-based maps enable significant representation compression, allowing mapping of larger environments. An object's point cloud can be replaced by a node storing the pose of the object, which can have a point cloud model in an offline database as described in Appendix item [10]. Additionally, the map replaces noisy object measurements with high fidelity, noise-free models.

However, none of these techniques learn the mobility of objects. Additionally, most existing systems do not incorporate knowledge from other systems such as manipulation or planning architectures to inform and improve localization and mapping. Hence, the SLAM approach is limited in various ways as noted above.

### SUMMARY OF THE INVENTION

The present invention overcomes disadvantages of the prior art by providing an object-based SLAM approach that defines a novel paradigm for simultaneous semantic tracking, object registration, and mapping (referred to herein as the system and method/process, “STORM”) according to an illustrative embodiment. While building a dense map of a dynamic environment, STORM identifies and tracks objects and localizes its sensor in the map. In contrast to most SLAM approaches, STORM models the trajectories of objects rather than assuming the objects remain static. STORM advantageously learns the mobility of objects in an environment and leverages this information when self-localizing its sensor by relying on those surrounding objects known to be mostly static. This solution enables a more flexible way for robots to interact with and manipulate an unknown environment than current approaches, while ensuring more robust localization in dynamic environments. STORM allows enhanced freedom in manipulation of objects, while contemporaneously estimating robot and object poses more accurately and robustly.

In an illustrative embodiment, a system and method for simultaneous localization, object registration, and mapping (STORM) of objects in a scene by a robot mounted sensor is provided. A sensor is arranged to generate a 3D representation of the environment. A module identifies objects in the scene from a database and establishes a pose of the objects with respect to a pose of the sensor. A front-end module uses measurements of the objects to construct a factor graph, and determines mobile objects with respect to stationary objects and accords differing weights to mobile objects versus stationary objects. A back-end module that optimizes the factor graph and maps the scene based on the determined stationary objects. The factor graph can include nodes representative of robot poses and object poses and constraints. The robot poses and the object poses are arranged with respect to a Special Euclidean (SE₃) space. The constraints can comprise at least one of (a) constraints from priors, (b) odometry measurements (c) a loop closure constraint for when the robot revisits part of the environment, (d) SegICP object measurements, (e) manipulation object measurements, (f) object motion measurements, and (g) robot mobility constraints. The constraints from priors can comprise at least one of locations of objects or other landmarks, a starting pose for the robot, and information regarding reliability of the constraints from the priors. The sensor can comprise a 3D camera that acquires light-based images of the scene and generates 3D point clouds. The module that identifies the objects can be based on PoseNet. The sensor can be provided to the robot, and the robot is arranged to move with respect to the environment based on a map of the scene.

### BRIEF DESCRIPTION OF THE DRAWINGS

The invention description below refers to the accompanying drawings, of which:

FIG. 1 is a diagram of a typical environment in which a robot moves and acquires sensor data (e.g. 3D images) of both stationary/fixed and moving/movable objects and associated processors therefor;

FIG. 2 is factor graph used in modeling an exemplary environment and sensor trajectory;

FIG. 3 is a diagram of a sensor measuring the relative poses of exemplary objects in a scene;

FIG. 4 is an exemplary factor graph constructed from the measurements taken by the sensor in FIG. 3;

FIG. 5 is a diagram depicting an overview of a SegICP pipeline with an RGB frame passed into a convolutional neural network; and

FIG. 6 shows an exemplary result of the SegICP pipeline of FIG. 5.

### DETAILED DESCRIPTION

### A. System Overview

In various embodiments, the present invention can provide a novel solution that can simultaneously localize a robot equipped with a depth vision sensor and create a tri-dimensional (3D) map made only of surrounding objects. This innovation finds applicability in areas like autonomous vehicles, unmanned aerial robots, augmented reality and interactive gaming, assistive technology.

Compared to existing Simultaneous Localization and Mapping (SLAM) approaches, the present invention of Simultaneous Tracking (or “localization”), Object Registration, and Mapping (STORM) can maintain a world map made of objects rather than 3D cloud of points, thus considerably reducing the computational resources required. Furthermore, the present invention can learn in real time the semantic properties of objects, such as the range of mobility or stasis in a certain environment (a chair moves more than a book shelf). This semantic information can be used at run time by the robot to improve its navigation and localization capabilities. As a non-limiting example, a robot can estimate its location more robustly and accurately by relying more on static objects rather than on movable objects because the present invention can learn which objects in an environment are more mobile and which objects are more static. As a result, the present innovation can enable a more accurate and flexible way for robots to interact with an unknown environment than current approaches.

STORM can simultaneously execute a number of operations: identifying and tracking objects (static, moving, and manipulated) in the scene, learning each object class's mobility, generating a dense map of the environment, and localizing its sensor in its map relying on more static objects. To accomplish these tasks, the STORM pipeline can be divided into a learning phase and an operational phase. Note that the term “simultaneous”, as used herein in various forms, can be taken broadly to include states in which there are small temporal breaks or discontinuities between certain operations, which can otherwise run generally “concurrently” or “contemporaneously”.

During the learning phase, STORM can learn the mobility of objects. By way of non-limiting example, STORM can observe over multiple trials the objects in an environment and can measure the relative transformations between them. These measurements are a potential technique by which STORM to determine the object class's mobility metric. The mobility metric can be a measure of how mobile or static an object or class of objects are, after a number of observations over a certain time window.

During the operation phase, STORM can build a map of its environment while tracking objects and localizing in the map. STORM can use the learned object mobilities to localize using more static objects.

Current SLAM technology can use a factor graph to model its environment and sensor trajectory, as would be clear to one skilled in the art. As a robot moves through an environment, a factor graph can be constructed that has nodes corresponding to the poses of the robot at different times, and whose edges can represent constraints between the poses. The edges are obtained from observations of the environment or from movement of the robot. Once such a graph is constructed, a map can be computed by finding the spatial configuration of the nodes that is most consistent with the measurements modeled by the edges. Such a map can assist a mobile robot in navigating in unknown environments in absence of external referencing systems such as GPS. Solutions can be based on efficient sparse least squares optimization techniques. Solutions can allow the back end part of the SLAM system to change parts of the topological structure of the problem's factor graph representation during the optimization process. The back end can discard some constraints and can converge towards correct solutions even in the presence of false positive loop closures. This can help to close the gap between the sensor-driven front end and the back-end optimizers, as would be clear to one skilled in the art. This use of factor graphs is described more fully below, and in Appendix items [4], [23], and [27], the entire contents of which are referenced as useful background information.

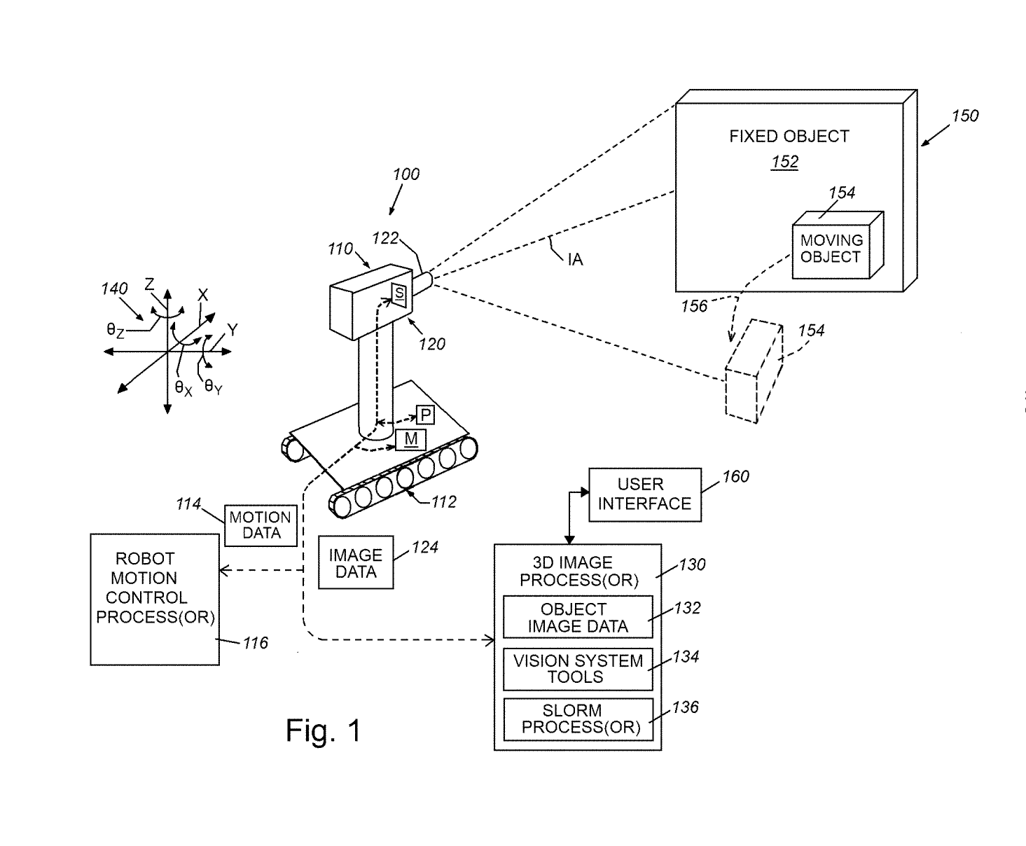

Reference is made to FIG. 1, by way of example, showing an environment 100 in which a moving robot 110 operates. The robot 110 can represent any device that can move in and/or observe its environment in multiple degrees of freedom. Thus, a terrestrial robot with a traction assembly 112 and associated motor/motor controller M is depicted. In alternate embodiments, the robot can be aquatic and include an arrangement that allows travel in and/or under water, or the robot can be aerial (e.g. a drone) with appropriate thrust-generating mechanisms. It can also be capable of space travel—e.g. a probe, satellite, etc. The robot can, likewise, be a combination of terrestrial, aerial, space-borne and/or aquatic.

The robot motor/controller M responds to control signals and data (e.g. motion feedback) 114 that are generated by a processor arrangement 116. As described below, the processor 116 can interoperate with the sensor process(or) 130 (described further below) to guide motion of the robot through the environment 100. Note that the robot can also include a position sensor assembly P that can be based on an inertial guidance feedback system and/or a GPS-based position. This position sensor assembly provides feedback as to the robot's relative position and/or orientation in the environment and can interoperate with the motion control process(or) 116. This position sensor P assembly can also be used to establish a global coordinate system (e.g. coordinates 140) that is employed to orient the robot with respect to the environment and orient sensor data with respect to the robot. The position sensing arrangement can include feedback as to the relative orientation of the sensor assembly 120 and (e.g.) its corresponding image axis IA.

The exemplary robot 110 includes an environmental sensor assembly 120, which in this arrangement includes a camera assembly with optics 122 and an image sensor S. The sensor can be non-optical and/or can include modalities for sensing an environment in the non-visible spectrum. It can also employ sonar or a similar medium to sense its environment. In this example, the sensor assembly is adapted to generate 3D image data 124 in the form of range images and/or point 3D point clouds.

The 3D sensor assembly 120 can be based on a variety of technologies in order to capture a 3D image (range image) and/or 3D point cloud of an object in a scene. For example, structured light systems, stereo vision systems, DLP metrology, LIDAR-based systems, time-of-flight cameras, laser displacement sensors and/or other arrangements can be employed. These systems all generate an image that provides a range value (e.g. z-coordinate) to pixels.

A 3D range image generated by various types of camera assemblies (or combinations thereof) can be used to locate and determine the presence and location of points on the viewed object's surface. The image data is mapped to a given 3D coordinate system. As shown, a Cartesian coordinate system 140 is defined by the image processor 130 with respect to the sensor 120 and associated robot 110. This coordinate system defines three axes x, y and z and associated rotations, θₓ, θ_{y}, and θ_{z}, about these respective axes. Other coordinate systems can be employed.

As shown, the robot 110 and associated sensor assembly 120 are located with respect to a scene 150 that can contain one or more objects. For the purposes of this description, at least one of the objects defines a relatively fixed or stationary object 152 (e.g. a window, shelf, etc.) and at least one movable or moving object 154. The movable object 154 is shown moving (dashed arrow 156) between a first position at a first time and a second position and/or orientation at a second time (shown in phantom). In general, fixed objects/landmarks allow for reliable application of the STORM process herein. Moving objects can be registered relative to fixed objects as described below.

The image process(or) 130 can comprise an acceptable processing arrangement including one or more purpose-built processors (e.g. FPGAs, Microprocessors, etc.), or a general purpose processor, such as a PC with appropriate interface(s). The process(or) 130 can be provided onboard with the robot and/or partially or fully located remotely and interconnected by an appropriate wireless and/or wired link using appropriate communication protocols that should be clear to those of skill. The process(or) 130 includes a variety of functional components or modules including, but not limited to a module 132 that acquires and stores object image data (e.g. point clouds) from trained and runtime objects. Operation of the process(or) 130 and input/manipulation of data during training time and runtime can be implemented using an appropriate user interface 160 that should be clear to those of skill. For example, the user interface 160 can include a display with touchscreen, mouse, keyboard, etc.

The process(or) 130 also includes a vision tool module and associated processes(ors) 134. Vision tools can include edge-finders, blob analyzers, center-of-mass locators, and any other tool or function that allows for analysis and/or manipulation of acquired sensor data. Also included in the STORM process(or) 136 that carries out the various functions in accordance with the exemplary embodiment herein. These functions are now described in further detail.

### B. Factor Graph

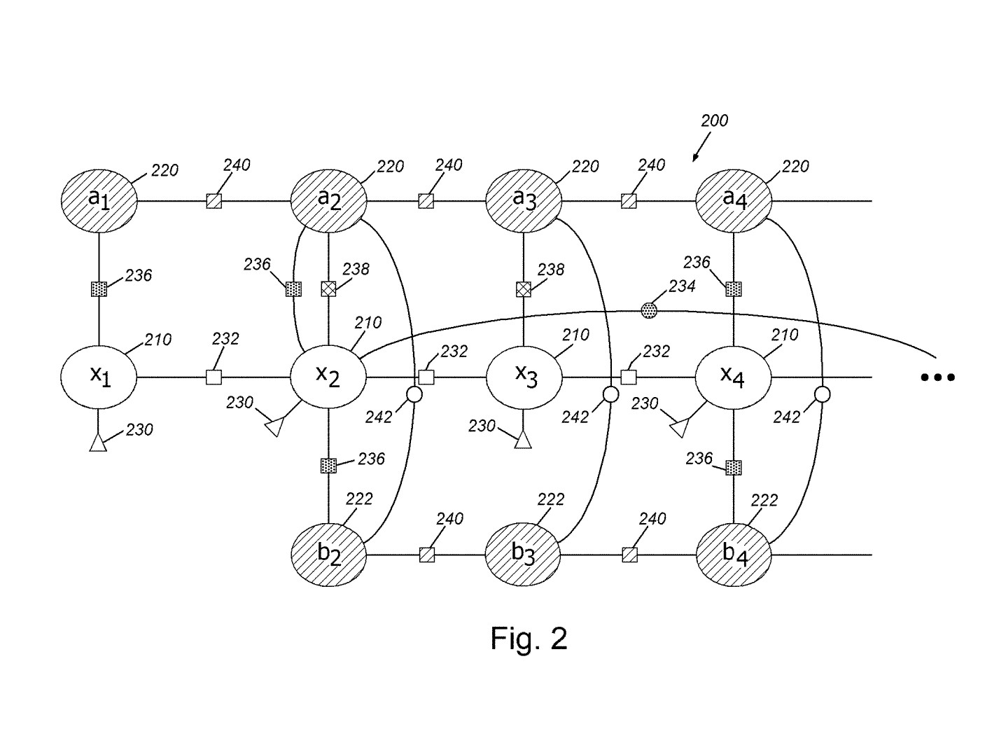

FIG. 2 is an exemplary, novel factor graph 200 used by STORM in modeling an environment and sensor trajectory. STORM nodes are shown as circles. The hollow (unshaded) circles 210 represent robot poses (X₁, X₂, X₃, X₄, etc.) and the slash-hatch-shaded circles 220 and 222 represent respective object poses (a₁, a₂, a₃, a₄, etc., and b₁, b₂, b₃, b₄, etc.) in the special Euclidean SE₃. Factors are shown as squares, triangles or circles. The hollow (unshaded) triangles 230 represent constraints from the priors and absolute pose measurements. The constraints from priors (230) can include locations of objects or other landmarks, the starting pose for the robot, information regarding the reliability of the constraints from the priors, or other data. Hollow (unshaded) squares 232 represent odometry measurements. The dot-shaded circle 234 represents a loop closure (when the robot revisits part of the environment) constraint. The dot-shaded squares 236 represent SegICP object measurements. The cross-hatch-shaded squares 238 represent manipulation object measurements. The slash-hatch-shaded squares 240 represent object motion measurements. The hollow (unshaded) circles 242 represent mobility constraints.

As shown in FIG. 2, the nodes 210 and 220 and 222 respectively represent the robot and object poses in SE₃, and the factors 230, 232, 234, 236, 238, 240 and 242, represent probabilistic constraints over the nodes. Unlike existing SLAM factor graph representations, STORM includes factors between the objects encoding the objects' different mobilities. These object mobilities can be relative to other objects. As it explores the environment, STORM thereby constructs a factor graph with sensor measurements and also optimize the graph.

Finding the most likely sensor trajectory and map state can be equivalent to finding the most likely configuration of the factor graph. This task can provide a maximum a posteriori (MAP) estimation problem. Thus, as the robot explores an environment and updates the factor graph, STORM is adapted to solve this problem by incrementally smoothing the factor graph.

### C. STORM Architecture

Like current SLAM approaches, STORM can be divided into two components: the front end and the back end, which can be implemented as software process (and/or hardware) modules. These components can work together to maintain the illustrative factor graph 200 and provide the best estimate of the environment. The front end creates the factors and nodes in the factor graph 200, while the back end performs MAP estimation to update the graph. The front end processes sensor data. It can extract and track relevant features to create the sensor measurements and can also associate the measurements with their respective objects in the factor graph. This task can be referred to as the data association problem. These measurements can be used to create the factors and link nodes in the factor graph. By way of non-limiting example, the back end computes the most likely graph configuration using least squares optimization techniques. Once the graph is optimized, the map can be generated. The following is a brief description of the Front End and Back End:

1) Front End: The front end of STORM is responsible for constructing the factor graph accurately. In each sensor data frame, the front end can identify and track objects and then associate them with nodes in the factor graph. This responsibility can be referred to as the short term data association problem. Using the back end's optimized graph, the front end can also determine when the sensor returns to a previous pose. This event is known as a loop closure. Detecting loop closures is referred to as the long term data association problem.

In an embodiment, a convolutional neural network, PoseNet (code and a dataset available from Cambridge University, UK, which allows for visual localization from (e.g.) a single landmark image that is compared to a large, stored database of such objects/landmarks), can be used to determine the pose of objects in the sensor frame. Illustratively, PoseNet solves the short term data association problem by identifying and tracking objects. Estimated object poses are input into the factor graph with the learned mobility constraints. For solving the long term data association problem, STORM can compare the topology of the objects in the sensor frame against the global factor graph. When at least three objects are detected, STORM can construct a local factor graph of the relative measurements from the sensor to the objects. This graph that can be created in the learning phase is explained more fully below. This graph can be matched against the current global graph maintained by the back end. When the difference in poses is within a predetermined threshold, a loop closure is made.

In an embodiment, the ConvNet architecture for PoseNet can be used, such as described in Appendix item [28], the entire contents of which is referenced as useful background information. As would be clear to one skilled in the art, Appendix item [28] describes a convolutional neural network that can be trained to regress the six-degrees-of-freedom camera pose from single images in an end to end manner, and can do so without the need for (free of) additional engineering or graph optimization. Convnets can be used to solve complicated out of image plane regression problems, and results can be achieved by using a multi-layer deep convnet. By way of non-limiting example, PoseNet can be trained on autolabeled data taken (e.g.) in the MIT Computer Science and Artificial Intelligence Laboratory (CSAIL) using a Northern Digital Inc. Optotrak Certus motion capture system. This approach can be generalized to a variety of data and/or classes of objects.

2) Back End: The back end of STORM uses the graph constructed by the front end, and compute the most likely robot trajectory and map state with MAP (Maximum A-Posteriori) estimation. Object mobilities can be updated using the optimized graph factors. In an embodiment, STORM can receive a prior about its state from a task and motion planner, as described in Appendix item [29], which is referenced herein in its entirety as useful background information. As described in Appendix item [29], an integrated strategy for planning, perception, state-estimation, and action in complex mobile manipulation domains can be based on planning in the belief space of probability distributions over states using hierarchical goal regression that can include pre-image back-chaining. A relatively small set of symbolic operators can give rise to task-oriented perception in support of the manipulation goals, and can result in a flexible solution of a mobile manipulation problem with multiple objects and substantial uncertainty, as would be clear to one skilled in the art. In an embodiment, STORM can efficiently solve this non-linear least squares optimization problem incrementally with (e.g.) the Georgia Tech Smoothing and Mapping (GTSAM) library or another appropriate dataset, such as described in Appendix item [30] and referenced herein in its entirety as useful background information. Such a database can exploit sparsity to provide solutions while being computationally efficient. In various embodiments, the measurements can provide information on the relationship between a handful of variables, and hence the resulting factor graph can be sparsely connected. This can be exploited by implementation of GTSAM to reduce computational complexity. Even when graphs are too dense to be handled efficiently by direct methods, GTSAM can provide iterative methods that can be efficient, as will be clear to one skilled in the art.

i. Learning Phase

Learning the constraints to accurately encode the object class's mobilities in STORM's back end factor graph representation can be part of the localization, mapping, and object tracking. In the learning phase, STORM can run multiple trials in an environment to learn object classes' mobilities. In each individual trial, the environment can remain static. Between trials, objects in the environment may move. STORM can measure each of the objects' relative poses in the sensor coordinate frame using its front end. With the poses, a complete factor graph of the objects in the environment can be constructed.

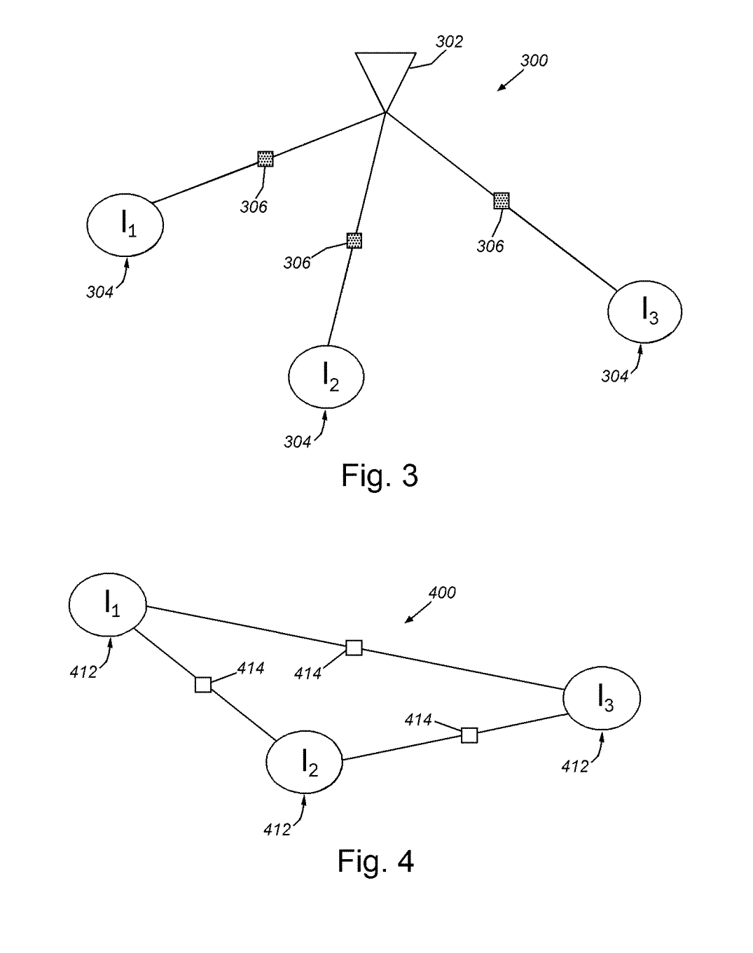

As shown in the factor graph 300 representing the learning phase in FIG. 3, the STORM front end is used to measure the relative poses of the objects in the scene. The sensor used for the STORM front end is represented by the triangle 302. Nodes are represented as circles and factors are represented as squares. The nodes 304 represent object poses (l₁, l₂, l₃, etc.). The squares 306 represent object measurements. As shown in corresponding FIG. 4, the constructed factor graph 400 of measurements is used to construct a complete graph out of the objects 412 (l₁, l₂, l₃, etc.). The objects 412 are constrained by relative transformations through the factors represented as squares 414, as shown.

The nodes can be the objects with their relative poses and the factors can encode the relative transformations between the objects. The sensor measurements can be used to compute the relative transformations. For each transformation between a pair of objects (including those of the same class), STORM can compute the mean and covariance of the rotation and translation in the Special Euclidean 3-dimensional group (SE₃). An object class's mobility can be represented by the covariances of its relative transformations with neighboring objects in the graph.

ii. Operation Phase

During the operation phase, STORM can build a map of the environment while tracking objects and localizing in the map using the learned object mobilities. It can localize in a dynamic environment with static, moving, and directly manipulated objects.

The STORM front end can construct the factor graph for the STORM backend. The front end can measure the relative pose of visible objects in the sensor's coordinate frame. It can use the learned object class' mobilities to weight measurements according to the object mobilities.

The covariance of an object measurement can be a function of the measurement noise and the learned mobilities (covariances) of the neighboring objects. Measurements of a more static object can result in measurements with lower covariance. Accordingly, measurements with static objects can be given more weight in the factor graph optimization. Consequently, localization can depend on more static objects than less static objects, thereby improving localization accuracy and robustness in dynamic environments.

When an object is directly manipulated, STORM can modify the covariances of the object's adjacent factors. Using information from the kind of system executing the manipulation task (robot, external user, etc.), STORM can then increase the covariances as a function of the magnitude of the translation and rotation in SE₃.

These updates to the covariances can allow the factor graph to keep track of dynamic environments and/or interactions with the environment. This is a significant improvement over the standard factor graph SLAM approach that models measurement covariance as a function of just the measurement noise. Unlike the standard factor graph SLAM approach, STORM works well for both static environments and dynamic ones.

As a robot navigates through an environment, the STORM backend can incrementally smooth the graph to find the most likely robot trajectory and object configuration. From this optimized graph, STORM can generate the map. The robot can then use the map to navigate appropriately with respect to the environment.

### D. Map Generation

STORM can generate a dense point cloud map of the environment. The map can contain noise-free, high fidelity object models from a database and background point clouds measured by the sensor. In an embodiment, before STORM is run, the object database can be created by laser scanning the objects, manually editing the point clouds, and storing the meshes that are generated thereby.

Once the factor graph is optimized, STORM can project the object models and background point clouds into a global coordinate frame. Point clouds of the background scene can exclude object points to avoid aliasing with the object point clouds. These background point clouds can be generated from the original sensor point clouds at each sensor pose. This can be done by first computing the concave hull of the objects' database point clouds in the sensor frame. Then, all points inside the hull can be removed from the background cloud.

### E. Factor Graph Representation

As mentioned previously, STORM can represent its trajectory and the environment with a factor graph that includes additional novel factors and edges between the objects. The objects can be landmarks. STORM can use MAP estimation to determine the most likely configuration of nodes.

The present invention significantly improves on previous formulations by accounting for learned object mobilities. This is shown in the below formulation in general terms of X and Z for simplicity of notation.

X is defined as a sequence of multivariate random variables representing the estimated state, containing the robot pose (denoted by R⊆X) and landmark poses (denoted by L⊆X) in SE₃. X₀ . . . t denotes the history of the state up to the current time. Z is a set of measurements containing: the poses of the tracked objects (denoted by O⊆Z) in the sensor frame, the relative transformations between consecutive sensor poses, also known as odometry measurements, (denoted by U⊆Z), the relative transformations between non-consecutive sensor poses, also known as loop closures, (denoted by C⊆Z), and/or the relative transformations between each object (denoted by P⊆Z). M is a set of covariances corresponding to the relative transformations between each object (P). These covariances represent the object pairs' relative mobilities. Each measurement in Z is expressed as a function of a subset of X as follows:

Z^{k}=hₖ(X^{k})+fₖ(M^{k},ϵₖ) Equation (1)

where hₖ(⋅) is a non-linear function dependent on the sensor used, fₖ(⋅) is a non-linear function dependent on whether the object is manipulated, X^{k}⊆X, M^{k}⊆M, and ϵₖ is zero mean Gaussian measurement noise.

Therefore,

Z^{k}˜ [symbol] [symbol] hₖ(X^{k}),fₖ(M^{k},ϵₖ) [symbol] Equation (2)

The STORM problem can be formulated as a MAP estimate, where X^{L} is the most likely node configuration

$${X}^{*} = {arg max}_{X} P ( {X}_{0 … t} \vert {Z}_{0 … t} ) = {arg max}_{X} P ( {Z}_{0 … t} \vert {X}_{0 … t} ) P ( {X}_{0 … t} ) \qquad Equation ( 3 )$$

where Bayes' rule is used for the last equality and P(Xt) is the prior and is initialized to a uniform distribution unless a prior is received.

Since our system moves between each measurement, measurement noise is assumed to be independent. This allows us to make the factorization of Equation (3)

$${X}^{*} = {arg max}_{X} P ( {X}_{t} ) {\prod }_{k = 1}^{m} P ( {Z}_{t}^{k} \vert {X}_{t} ) = {arg max}_{X} P ( {X}_{t} ) {\prod }_{k = 1}^{m} P ( {Z}_{t}^{k} \vert {X}_{t}^{k} ) \qquad Equation ( 4 )$$

where Zₜ^{k} only depends on a subset of Xₜ. The information matrix Ωₖ (inverse of the covariance matrix) represent fₖ(M^{k},Eₖ). From Equation (2), it is known that

$$P ( {Z}_{t}^{k} \vert {X}_{t}^{k} ) = \frac{1}{\sqrt{2 π \vert {Ω}_{k}^{- 1} \vert}} exp ( - \frac{1}{2} {( {Z}_{t}^{k} - {h}_{k} ( {X}_{t}^{k} ) )}^{⊤} {Ω}_{k}^{- 1} ( {Z}_{t}^{k} - {h}_{k} ( {X}_{t}^{k} ) ) ) \qquad Equation ( 5 )$$

Using the definition of Mahalanobis distance,

∥a−b∥_{Ω}_{^{−1}}²=(a−b)^{T}Ω(a−b) Equation (6)

Equation (5) is be simplified

$$P ( {Z}_{t}^{k} \vert {X}_{t}^{k} ) = \frac{1}{\sqrt{2 π \vert {Ω}_{k}^{- 1} \vert}} exp ( - \frac{1}{2} {‖ {Z}_{t}^{k} - {h}_{k} ( {X}_{t}^{k} ) ‖}_{{Ω}^{- 1}}^{2} ) ∝ exp ( - \frac{1}{2} {‖ {Z}_{t}^{k} - {h}_{k} ( {X}_{t}^{k} ) ‖}_{{Ω}^{- 1}}^{2} ) \qquad Equation ( 7 )$$

The prior is assumed to be formulated similarly

$$P ( {X}_{t} ) ∝ exp ( - \frac{1}{2} {‖ {Z}_{t}^{0} - {h}_{0} ( {X}_{t}^{0} ) ‖}_{{Ω}^{- 1}}^{2} ) \qquad Equation ( 8 )$$

which simplifies Equation (4)

$${X}^{*} = {arg max}_{X} P ( {X}_{t} ) {\prod }_{k = 1}^{m} P ( {Z}_{t}^{k} \vert {X}_{t}^{k} ) = {arg max}_{X} {\prod }_{k = 0}^{m} P ( {Z}_{t}^{k} \vert {X}_{t}^{k} ) \qquad Equation ( 9 )$$

Because maximizing the posterior is equivalent to minimizing the negative log posterior,

$${X}^{*} = {arg max}_{X} {\prod }_{k = 0}^{m} P ( {Z}_{t}^{k} \vert {X}_{t}^{k} ) = {arg min}_{X} - log ( {\prod }_{k = 0}^{m} P ( {Z}_{t}^{k} \vert {X}_{t}^{k} ) ) = {arg min}_{X} {\sum }_{k = 0}^{m} {‖ {Z}_{t}^{k} - {h}_{k} ( {X}_{t}^{k} ) ‖}_{{Ω}^{- 1}}^{2} \qquad Equation ( 10 )$$

X* is found efficiently using a modern SLAM library, such as, by way of non-limiting example, the Georgia Tech Smoothing and Mapping (GTSAM) library of Appendix item [30], the entire content of which is referenced as useful background information, and described above.

In an embodiment, a novel real time object registration pipeline (SegICP) can be used instead of the PoseNet code and dataset. SegICP is capable of tracking multiple objects simultaneously with pose error on the order of centimeters without (free-of) requiring any trained network, thus reducing the overall time required for training and the memory size for maintaining this information on board. This system can be used with the learning phase and STORM backend as a potential alternative to PoseNet.

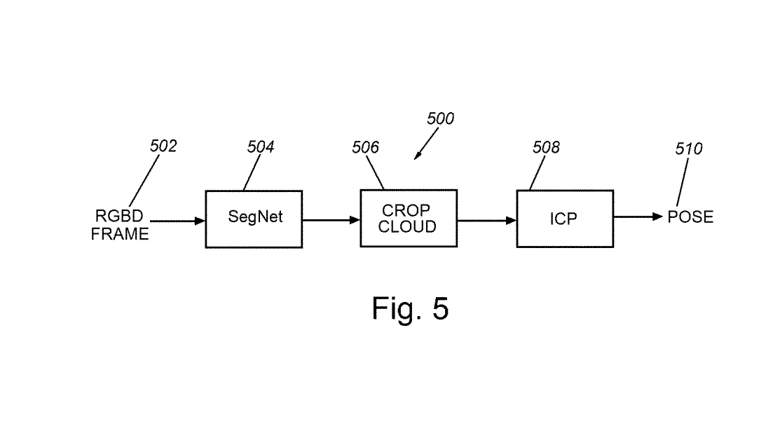

FIG. 5 is a flow diagram 500 depicting an overview of an exemplary SegICP pipeline with an RGB frame passed into a convolutional neural network referred to herein as SegNet. RGB-D frames 502 from a RGB-D sensor can be passed through SegNet, at block 504. In an embodiment, SegNet can use the ConvNet architecture described in Appendix item [31], the entire contents of which is referenced as useful background information. As described in Appendix item [31], and as will be clear to one skilled in the art, SegNet can be a fully convolutional neural network architecture for semantic pixel-wise segmentation. This core trainable segmentation engine can consist of an encoder network, and a corresponding decoder network followed by a pixel-wise classification layer. The architecture of the encoder network can be topologically similar to a thirteen (13) convolutional layer architecture in a VGG16 network, as will be clear to one skilled in the art. The decoder network can map the low-resolution encoder feature maps to full-implement-resolution feature maps for pixel-wise classification. The decoder of SegNet can upsample the lower-resolution input feature maps using pooling indices computed in the max-pooling step of the corresponding encoder to perform non-linear upsampling, which can eliminate the need for learning to upsample. The upsampled maps can be sparse and can be convolved with trainable filters to produce dense feature maps. The ConvNet architecture of SegNet can be trained on data containing various objects that are trained and stored in an appropriate database. SegNet segments the image and passes the mask to a program which crops the point cloud from the sensor at block 506. SegNet then outputs a segmented mask with pixel wise semantic object labels. This mask can be used to crop the point cloud from the sensor at block 506, generating individual point clouds for each detected object. The cropped point cloud is passed to an iterative closest point (ICP) algorithm functional block 508, which registers the object point cloud with cropped point cloud. In an embodiment, an implementation of ICP from the Point Cloud Library (PCL) described in Appendix item [32], the entire contents of which is referenced as useful background information, can be used to register each object's point cloud with its full point cloud database model at block 508. As described in Appendix item [32], the PCL can incorporate a multitude of 3D processing algorithms that can operate on point cloud data, including filtering, feature estimation, surface reconstruction, registration, model fitting, segmentation, and others. ICP returns the pose 508 of the object with respect to the RGB-D sensor.

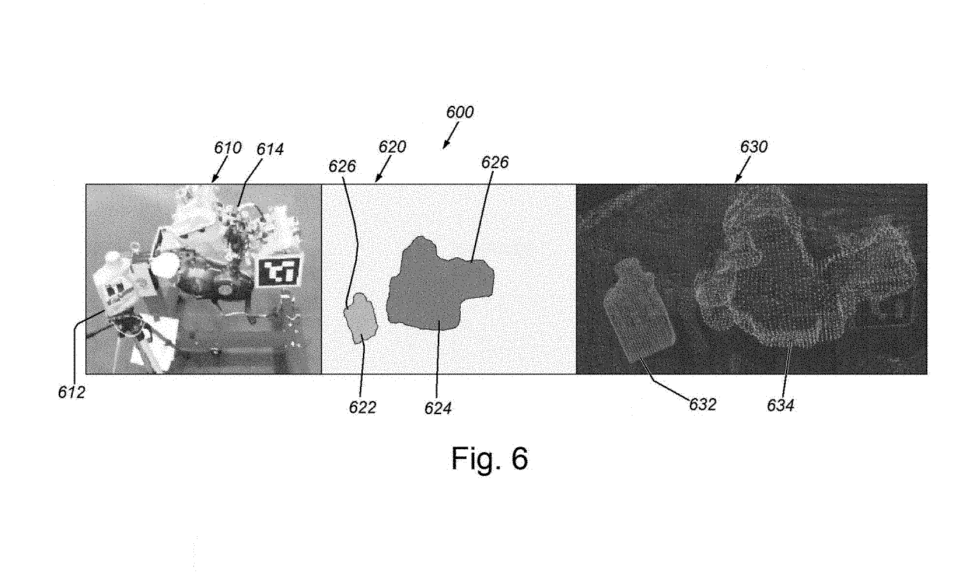

FIG. 6 shows a series of exemplary image frames 600 with the results of the SegICP pipeline of FIG. 5. Image frame 610 shows the original RGB image. Image frame 620 shows the segmented RGB mask, output by SegNet. The pixels 622 represent labels for the imaged oil bottle 612 in the original image 610 labels, the pixels 624 represent labels for the imaged engine 614 in the original image 610, and the surrounding pixels 626 are background labels. Image frame 630 shows the registered model object clouds with the scene point cloud. The points 632 are the oil bottle model points and the points 634 are the engine model points. Additionally, the object database as described above has been created as a background in this frame 630.

In an alternate embodiment, instead of the loop closure method described above, the method suggested in Appendix item [10] can be used. As described in Appendix item [10], real-time 3D object recognition and tracking can provide six (6) degrees of freedom camera-object constraints which can feed into an explicit graph of objects, continually refined by efficient pose-graph optimization. This can offer the descriptive and predictive power of SLAM systems which perform dense surface reconstruction, but can do so with a huge representation compression. The object graph can enable predictions for accurate ICP-based camera to model racking at each live frame, and efficient active search for new objects in currently undescribed image regions. This method can include real-time incremental SLAM in large, cluttered environments, including loop closure, relocalization and the detection of moved objects, and the generation of an object level scene description with the potential to enable interaction. Using this alternate method, when at least 3 objects are detected, STORM can construct the same local graph as described above. In contrast to the approach described above, this graph and current global graph maintained by the back end can be transformed into meshes, where the nodes can be points in the mesh. The geometric feature-based pose estimation system from Appendix item [10] can be used to attempt to align the local and global graph. If the score is high enough, a loop closure can be made.

### F. Conclusion

It should be clear that the STORM process described herein provides an effective technique for tracking within an environment made of various objects in a manner that accommodates movement of such objects and that significantly reduces processing overhead and increases speed where real time processing by a robot is desired. This system and method effectively utilizes existing code and databases of objects and is scalable to include a myriad of object types and shapes as needed for a task.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, as used herein the terms “process” and/or “processor” should be taken broadly to include a variety of electronic hardware and/or software based functions and components (and can alternatively be termed functional “modules” or “elements”). Moreover, a depicted process or processor can be combined with other processes and/or processors or divided into various sub-processes or processors. Such sub-processes and/or sub-processors can be variously combined according to embodiments herein. Likewise, it is expressly contemplated that any function, process and/or processor herein can be implemented using electronic hardware, software consisting of a non-transitory computer-readable medium of program instructions, or a combination of hardware and software. Additionally, as used herein various directional and dispositional terms such as “vertical”, “horizontal”, “up”, “down”, “bottom”, “top”, “side”, “front”, “rear”, “left”, “right”, and the like, are used only as relative conventions and not as absolute directions/dispositions with respect to a fixed coordinate space, such as the acting direction of gravity. Additionally, where the term “substantially” or “approximately” is employed with respect to a given measurement, value or characteristic, it refers to a quantity that is within a normal operating range to achieve desired results, but that includes some variability due to inherent inaccuracy and error within the allowed tolerances of the system (e.g. 1-5 percent). Additionally, multiple sensors can be employed by a single robot, thereby sensing different directions simultaneously, or multiple robots can exchange sensed data and/or collaboratively construct factor graphs and/or maps together. Accordingly, this description is meant to be taken only by way of example, and not to otherwise limit the scope of this invention.

### APPENDIX

The following references are all incorporated herein by reference in their entirety as useful background information:
[1] H. Durrant-Whyte and T. Bailey, “Simultaneous localization and mapping: part i,” Robotics & Automation Magazine, IEEE, vol. 13, no. 2, pp. 99-110, 2006.
[2] T. Bailey and H. Durrant-Whyte, “Simultaneous localization and mapping (slam): Part ii,” IEEE Robotics & Automation Magazine, vol. 13, no. 3, pp. 108-117, 2006.
[3] S. Thrun et al., “Robotic mapping: A survey,” Exploring artificial intelligence in the new millennium, vol. 1, pp. 1-35, 2002.
[4] C. Cadena, L. Carlone, H. Carrillo, Y. Latif, D. Scaramuzza, J. Neira, I. D. Reid, and J. J. Leonard, “Past, present, and future of simultaneous localization and mapping: Towards the robust-perception age,” arXiv preprint arXiv:1606.05830, 2016.
[5] J. Levinson, M. Montemerlo, and S. Thrun, “Map-based precision vehicle localization in urban environments.” in Robotics: Science and Systems, vol. 4. Citeseer, 2007, p. 1.
[6] A. J. Davison, I. D. Reid, N. D. Molton, and O. Stasse, “Monoslam: Real-time single camera slam,” IEEE transactions on pattern analysis and machine intelligence, vol. 29, no. 6, pp. 1052-1067, 2007.
[7] R. A. Newcombe, S. J. Lovegrove, and A. J. Davison, “Dtam: Dense tracking and mapping in real-time,” in 2011 international conference on computer vision. IEEE, 2011, pp. 2320-2327.
[8] R. A. Newcombe, S. Izadi, O. Hilliges, D. Molyneaux, D. Kim, A. J. Davison, P. Kohli, J. Shotton, S. Hodges, and A. Fitzgibbon, “Kinectfusion: Real-time dense surface mapping and tracking,” in Proceedings of the 2011 10th IEEE International Symposium on Mixed and Augmented Reality, ser. ISMAR '11. Washington, D.C., USA: IEEE Computer Society, 2011, pp. 127-136. [Online]. Available: http://dx.doi.org/10.1109/ISMAR.2011.6092378
[9] T. Whelan, S. Leutenegger, R. S. Moreno, B. Glocker, and A. Davison, “Elasticfusion: Dense slam without a pose graph,” in Proceedings of Robotics: Science and Systems, Rome, Italy, July 2015.
[10] R. F. Salas-Moreno, R. A. Newcombe, H. Strasdat, P. H. Kelly, and A. J. Davison, “Slam++: Simultaneous localization and mapping at the level of objects,” in Proceedings of the IEEE Conference on Computer Vision and Pattern Recognition, 2013, pp. 1352-1359.
[11] D. G′alvez-L′opez, M. Salas, J. D. Tard′os, and J. Montiel, “Real-time monocular object slam,” Robotics and Autonomous Systems, vol. 75, pp. 435-449, 2016.
[12] P. Tirilly, V. Claveau, and P. Gros, “Language modeling for bag-of-visual words image categorization,” in Proceedings of the 2008 international conference on Content-based image and video retrieval. ACM, 2008, pp. 249-258.
[13] N. Sunderhauf, T. T. Pham, Y. Latif, M. Milford, and I. Reid, “Meaningful maps □ object-oriented semantic mapping,” arXiv preprint arXiv:1609.07849, 2016.
[14] S. Choudhary, L. Carlone, C. Nieto, J. Rogers, Z. Liu, H. I. Christensen, and F. Dellaert, “Multi robot object-based SLAM,” in Intl. Symp. on Experimental Robotics. Tokyo, JP: IFRR, October 2016.
[15] J. Redmon, S. Divvala, R. Girshick, and A. Farhadi, “You only look once: Unified, real-time object detection,” arXiv preprint arXiv:1506.02640, 2015.
[16] S. Song, L. Zhang, J. Xiao, H. Beyhaghi, N. Dikkala, E. Tardos, Y. M′etivier, J. Robson, A. Zemmari, Z. Aghazadeh et al., “Robot in a room: Toward perfect object recognition in closed environments.”
[17] S. Choudhary, A. J. Trevor, H. I. Christensen, and F. Dellaert, “Slam with object discovery, modeling and mapping,” in 2014 IEEE/RSJ International Conference on Intelligent Robots and Systems. IEEE, 2014, pp. 1018-1025.
[18] C.-C. Wang, C. Thorpe, S. Thrun, M. Hebert, and H. Durrant-Whyte, “Simultaneous localization, mapping and moving object tracking,” The International Journal of Robotics Research, vol. 26, no. 9, pp. 889-916, 2007.
[19] C.-C. Wang, “Simultaneous localization, mapping and moving object tracking,” Ph.D. dissertation, University of Sydney, 2004.
[20] D. F. Wolf and G. S. Sukhatme, “Mobile robot simultaneous localization and mapping in dynamic environments,” Autonomous Robots, vol. 19, no. 1, pp. 53-65, 2005.
[21] A. Walcott-Bryant, M. Kaess, H. Johannsson, and J. J. Leonard, “Dynamic pose graph slam: Long-term mapping in low dynamic environments,” in 2012 IEEE/RSJ International Conference on Intelligent Robots and Systems. IEEE, 2012, pp. 1871-1878.
[22] A. Walcott, “Long-term robot mapping in dynamic environments,” Ph.D. dissertation, Massachusetts Institute of Technology, 2011.
[23] G. Grisetti, R. Kummerle, C. Stachniss, and W. Burgard, “A tutorial on graph-based slam,” IEEE Intelligent Transportation Systems Magazine, vol. 2, no. 4, pp. 31-43, 2010.
[24] R. A. Newcombe, D. Fox, and S. M. Seitz, “Dynamicfusion: Reconstruction and tracking of non-rigid scenes in real-time,” in Proceedings of the IEEE conference on computer vision and pattern recognition, 2015, pp. 343-352.
[25] B. P. W. Babu, C. Bove, and M. A. Gennert, “Tight coupling between manipulation and perception using slam.”
[26] L. Ma, M. Ghafarianzadeh, D. Coleman, N. Correll, and G. Sibley, “Simultaneous localization, mapping, and manipulation for unsupervised object discovery,” in 2015 IEEE International Conference on Robotics and Automation (ICRA). IEEE, 2015, pp. 1344-1351.
[27] N. Sunderhauf, “Robust optimization for simultaneous localization and mapping,” 2012.
[28] A. Kendall, M. Grimes, and R. Cipolla, “Posenet: A convolutional network for real-time 6-dof camera relocalization,” in Proceedings of the IEEE International Conference on Computer Vision, 2015, pp. 2938-2946.
[29] L. P. Kaelbling and T. Lozano-P′erez, “Integrated task and motion planning in belief space,” The International Journal of Robotics Research, p. 0278364913484072, 2013.
[30] F. Dellaert, “Factor graphs and gtsam: A hands-on introduction,” 2012.
[31] V. Badrinarayanan, A. Handa, and R. Cipolla, “Segnet: A deep convolutional encoder-decoder architecture for robust semantic pixel-wise labelling,” arXiv preprint arXiv:1505.07293, 2015.
[32] R. B. Rusu and S. Cousins, “3D is here: Point Cloud Library (PCL),” in IEEE International Conference on Robotics and Automation (ICRA), Shanghai, China, May 9-13, 2011.
[33] N. Koenig and A. Howard, “Design and use paradigms for gazebo, an open-source multi-robot simulator,” in Intelligent Robots and Systems, 2004. (IROS 2004). Proceedings. 2004 IEEE/RSJ International Conference on, vol. 3. IEEE, 2004, pp. 2149-2154.

What is claimed is:

1. A system for simultaneous localization, object registration, and mapping (STORM) of objects in a scene by a robot mounted sensor comprising:
a sensor arranged to generate a 3D representation of the environment;
a module that identifies objects in the scene from a database and establishes a pose of the objects with respect to a pose of the sensor;
a front-end module that uses measurements of the objects to construct a factor graph, and determines mobile objects with respect to stationary objects and accords differing weights to mobile objects versus stationary objects; and
a back-end module that optimizes the factor graph and maps the scene based on the determined stationary objects.

2. The system as set forth in claim 1 wherein the factor graph includes nodes representative of robot poses and object poses and constraints.

3. The system as set forth in claim 2 wherein the robot poses and the object poses are arranged with respect to a Special Euclidean space.

4. The system as set forth in claim 3 wherein the constraints comprise at least one of (a) constraints from priors, (b) odometry measurements, (c) a loop closure constraint for when the robot revisits part of the environment, (d) SegICP object measurements, (e) manipulation object measurements, (f) object motion measurements, and (g) robot mobility constraints.

5. The system as set forth in claim 4 wherein the constraints from priors comprise at least one of locations of objects or other landmarks, a starting pose for the robot, and information regarding reliability of the constraints from the priors.

6. The system as set forth in claim 1 wherein the sensor comprises a 3D camera that acquires light-based images of the scene and generates 3D point clouds.

7. The system as set forth in claim 6 wherein the module that identifies the objects is based on PoseNet.

8. The system as set forth in claim 1 wherein the sensor is provided to the robot and the robot is arranged to move with respect to the environment based on a map of the scene.

9. A method for simultaneous localization, object registration, and mapping (STORM) of objects in a scene by a robot mounted sensor comprising the steps of:
generating, with a sensor, a 3D representation of the environment;
identifying objects in the scene from a database,
establishing a pose of the objects with respect to a pose of the sensor;
constructing, using measurements of the objects, a factor graph representation to determine mobile objects with respect to stationary objects and according differing weights to mobile objects versus stationary objects; and
optimizing the factor graph and mapping the scene based on the determined stationary objects.

10. The method as set forth in claim 9 wherein the factor graph includes nodes representative of robot poses and object poses and constraints.

11. The method as set forth in claim 10 wherein the robot poses and the object poses are arranged with respect to a Special Euclidean space.

12. The method as set forth in claim 11 wherein the constraints comprise at least one of (a) constraints from priors, (b) odometry measurements, (c) a loop closure constraint for when the robot revisits part of the environment, (d) SegICP object measurements, (e) manipulation object measurements, (f) object motion measurements, and (g) robot mobility constraints

13. The method as set forth in claim 12 wherein the constraints from priors comprise at least one of locations of objects or other landmarks, a starting pose for the robot, and information regarding reliability of the constraints from the priors.

14. The method as set forth in claim 9 wherein the step of generating includes using a 3D camera that acquires light-based images of the scene and generates 3D point clouds.

15. The method as set forth in claim 14 wherein the step of identifying the objects is based on PoseNet.

16. The method as set forth in claim 9 wherein the sensor is provided to the robot, and further comprising, moving the robot with respect to the environment based on a map of the scene.

17. The method as set forth in claim 16 wherein the map comprises static and dynamic objects.
